(19) United States
(12) Patent Application Publication
(10) Pub. No.: US 2026/0064830 A1
(43) Pub. Date: Mar. 5, 2026

(54) Dynamic Provision of Different Application Types

(71) Applicant: Citrix Systems, Inc., Fort Lauderdale, CA (US)

(72) Inventors: Thierry Duchastel, Cooper City, FL (US); Santosh Sampath Gummunur Chiranjeevi, Bangalore (IN); Ashish Goyal, Bangaluru (IN); Nitin Kumar Mathur, Pompano Beach, FL (US); Anjaneya Padmakar Akondi, Boca Raton, FL (US); Praveen Raghuraman, Pleasanton, CA (US)

(21) Appl. No.: 18/819,442

(22) Filed: Aug. 29, 2024

(51) Int. Cl. G06F 21/53

(52) U.S. Cl. CPC G06F 21/53; G06F 2221/033

(57) ABSTRACT

Systems and methods described herein may store information about a Zero Trust (ZT) version of an application that is configured for local execution at user devices and a virtual version of the application that is configured for virtual execution in virtualization servers. A request for the application may be received from a user device along with parameters associated with the user device. The parameters may indicate whether the user device has joined a private domain, whether the user device has a certificate associated with the private domain, the physical location of the user device, whether the user device is executing an anti-virus application, etc. Either the ZT version of the application or the virtual version of the application may be selected for the user device based on the parameters provided by the user device.

### FIELD

Aspects described herein generally relate to computer networking, on-premise and remote computer access, virtual and zero trust network access applications, and hardware and software related thereto. More specifically, one or more aspects described herein enable dynamic provisions of virtual and zero trust network access applications.

### BACKGROUND

Due to increases in remote work and the use of mobile devices, organizations need a comprehensive strategy for secure “anytime, anywhere” access to their corporate resources (e.g., applications, legacy systems, data, etc.) regardless of the device configurations of the user devices (e.g., corporate-issued devices, personal devices, etc.) accessing the corporate resources. One method of securely accessing corporate resources anytime with user devices of different configurations may be via virtual applications, which are installed, hosted, and/or executed on virtualization servers located on-premise and/or in the cloud. However, latency (e.g., delay due to slow or unstable network connect, network congestions, insufficient resources, etc.) may be a disadvantage for virtual applications, especially real-time, graphics-intensive, or resource-hungry applications. Furthermore, hosting virtual applications in third party resources may introduce risks of data breaches, data loss, and/or system downtime. Additionally, there is a huge cost to maintain such virtualization servers.

Another method of securely accessing corporate resources may be via zero trust (ZT) applications executed at user devices using Zero Trust Network Access (ZTNA) protocols. ZTNA protocols might not trust users and user devices by default, even if the user devices are connected to a private domain of an organization and the users and their devices have been previously verified. ZTNA protocols may be implemented by establishing strong identity verification, validating user device and user compliance prior to granting access, and ensuring least privilege access to only explicitly authorized resources. Executing ZT applications may allow network administrators a granular view of network activities and/or reduce susceptibility to suspicious attacks by third parties. However, strict ZTNA protocols might not allow remote user devices outside the organization's premises to launch ZT applications.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems and methods of providing, to a user device, an appropriate version of an application (e.g., a virtual version of the application to be executed at a virtualization server or a ZT version of the application to be executed locally at the user device) based on the current configurations, status, and/or location of the user device.

In one or more examples, a computing system may include one or more processors and memory storing computer executable instructions that, when executed by the processors, cause the computing system to store a ZT version of the application that is configured for local execution at user devices and/or a virtual version of the application that is configured for virtual execution in virtual environments. The computing system may receive, from a user device, a request for the application and one or more parameters associated with the user device. The computing system may select, based on the request and the parameters, either the ZT version of the application or the virtual version of the application and send the selected version to the user device.

In one or more examples, the one or more parameters associated with the user device may indicate whether the user device has joined a private domain of an organization, whether the user device comprises a certificate issued by the organization or associated with the private domain, the physical location of the user device, whether the user device is executing an anti-virus application, and/or other parameters.

In one or more examples, a computing system may further store, for the application, one or more predetermined conditions associated with sending the ZT version of the application to the user device. The computing system may select the ZT version of the application based on determining that the stored one or more predetermined conditions are met by the one or more parameters associated with the user device. Alternatively, the computing system may select the virtual version of the application based on determining that the one or more predetermined conditions are not met by the one or more parameters associated with the user device.

In one or more examples, a computing system may receive a request for a list of applications available for the user device. Based on the request and the one or more parameters associated with the user device, the computing device may determine a first set of ZTNA applications that are configured for local execution at the user device and/or a second set of virtual applications that are configured for virtual execution in virtualization servers. The computing device may cause the user device to display a portal comprising the first set of applications and the second set of applications. In one or more examples, the first set of ZTNA applications and the second set of virtual applications may be available from an application store.

In one or more examples, a computing system may select the ZT version of the application based on the one or more parameters associated with the user device and send, to the user device, security policies associated with the ZT version of the application. Additionally, the computing system may cause the user device to execute the ZT version of the application based on the security policies. In one or more examples, the security policies may indicate restrictions in one or more of clipboard access, printing, downloading, capturing screenshots, keystroke logging, access to internal servers joined to a private domain, and/or access to servers external to the private domain.

In one or more examples, the ZT version of the application may be configured for local execution at the user device, and/or the virtual version of the application may be configured for virtual execution in one or more virtualization servers. In one or more examples, the one or more computing devices, the user device, and the one or more virtualization servers may be joined to a private domain of an organization. In other examples, the computing system and the one or more virtualization servers may be joined to the private domain, and the user device might not be joined to the private domain.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIGS. 3A, 3B, 3C, 3D, and 3E depict an illustrative computing environment for dynamic provisions of virtual and ZT applications.

FIG. 4 depicts an illustrative virtualization server for virtual applications that may be used in accordance with one or more illustrative aspects described herein.

FIG. 5 depicts an illustrative system architecture that may be used in accordance with one or more illustrative aspects described herein.

FIG. 6 depicts an illustrative event sequence for receiving predetermined conditions for provisions of ZT and virtual versions of applications and security policies for ZT applications in accordance with one or more illustrative aspects described herein.

FIG. 7 depicts an illustrative event sequence for providing a user device with a list of available applications in accordance with one or more illustrative aspects described herein.

FIG. 8 depicts an illustrative application portal.

FIG. 9 depicts an illustrative event sequence for launching a virtual version of an application in accordance with one or more illustrative aspects described herein.

FIG. 10 depicts an illustrative event sequence for launching a ZT version of an application in accordance with one or more illustrative aspects described herein.

FIGS. 11A and 11B depict an illustrative method for providing virtual and/or ZT versions of applications in accordance with one or more illustrative aspects described herein.

FIG. 12 depicts an illustrative method for receiving virtual and/or ZT versions of applications in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

Virtual Applications are applications optimized to run in a virtual environment that can reside on-premises or in the cloud. Zero Trust Network Access (ZTNA) systems may include a set of technologies and techniques that can provide user devices with secure remote access to applications and services based on defined access control policies. Unlike Virtual Private Networks (VPNs), which can grant complete access to entire private networks by default, ZTNA systems may default to deny access to all user devices except for those user devices whose users have been explicitly granted access. In some respects, a ZTNA system can act as a trust access broker, evaluating an access request from a user device to an application on a data center and providing access to the application via dedicated secure tunnels between the user device and the data center providing the application. Current solutions are either configured to provide only ZT versions of available applications using ZTNA solutions (e.g., Secure Private Access (SPA) developed by Citrix Systems, Inc. of Ft. Lauderdale, Florida) or only virtual versions of available applications (e.g., Citrix Virtual Apps and Desktop (CVAD) developed by Citrix Systems, Inc. of Ft. Lauderdale, Florida). Both virtual and ZT applications have different advantages and advantages, and it will be desirable for an organization to have the flexibility to provide either type of application to user devices.

As a general introduction to the subject matter described in more detail below, aspects described herein are directed towards providing a flexible architecture where either a ZT version of an application or a virtual version of an application may be provided to a user device based on the current device configurations, network configurations, and/or location of the user device. Applications described herein may provide, handle or use, at least in part, sensitive network traffic, such as an organization's confidential information, emails, documents or other communications that data centers can provide. Aspects described herein may provide an application portal to a user device, where the application portal displays a list of applications available to the user device from an application store. Each application in the displayed list of applications may be either the ZT version of the application or the virtual version of the application. For example, a ZT version of an application may be provided if the user device has joined a private domain of an organization providing the application to the user device, if the user device is present in the premises of the organization, and if the user device is executing an anti-virus application. Otherwise, a virtual version of the application may be provided to the user device. A user of the user device may be oblivious to whether the applications displayed in the application portal are ZT or virtual versions. In the flexible architecture described herein, the network administrators may specify conditions that a user device needs to meet to receive a ZT version of the application or the virtual version of the application. Allowing some of the users to run ZT versions of different applications may reduce the latency issues associated with only allowing the users to run virtual applications, improve the overall end-user experience (e.g., fast rollouts of ZT versions instead of waiting for resources at virtualization servers), and reduce traffic at virtualization servers.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

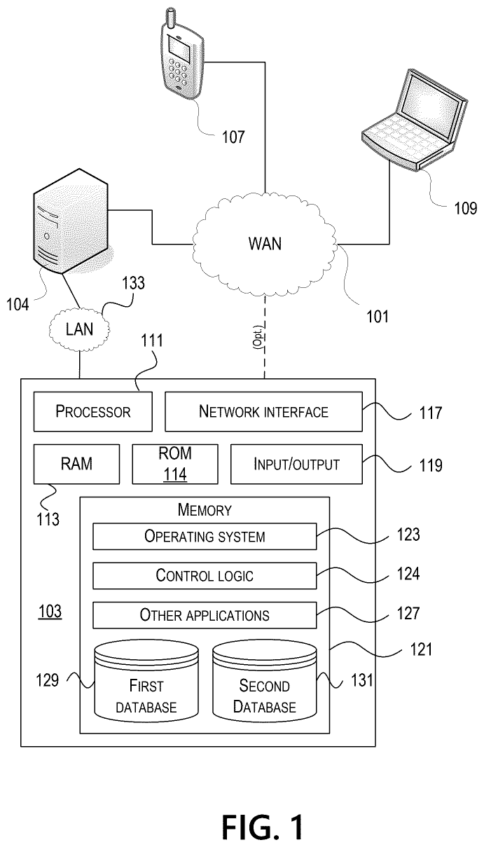

Computer software, hardware, and networks may be utilized in a variety of different system environments, including standalone, networked, remote-access (also known as remote desktop), on-premise, virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cables, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data centers 103, web server 105, and client computers 107, 109. Data center 103 may provide overall access, control and administration of databases and control software for performing one or more illustrative aspects described herein. Data center 103 may be connected to web server 105, through which users interact with and obtain data and/or applications as requested. Alternatively, data center 103 may act as a web server itself and be directly connected to the Internet. Data center 103 may be connected to web server 105 through the local area network 133, the wide area network 101 (e.g., the Internet), via direct or indirect connection, or via some other network. Users may interact with the data center 103 using remote computers 107, 109, e.g., using a web browser to connect to the data center 103 via one or more externally exposed web sites hosted by web server 105. Client computers 107, 109 may be used in concert with data center 103 to access data and/or applications stored therein, or may be used for other purposes. For example, from user device 107, a user may access web server 105 using an Internet browser, as is known in the art, or by executing a software application that communicates with web server 105 and/or data center 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services and/or applications provided by web server 105 and data center 103 may be combined on a single server.

Each component 103, 105, 107, 109 may be any type of known computer, server, or data processing device. Data center 103, e.g., may include a processor 111 controlling the overall operation of the data center 103. Data center 103 may further include random access memory (RAM) 113, read-only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling the overall operation of the data processing device 103, control logic 125 for instructing data center 103 to perform aspects described herein, and other application software 127 providing secondary, support, and/or other functionality which may or might not be used in conjunction with aspects described herein. The control logic 125 may also be referred to herein as the data center software 125. Functionality of the data center software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in the performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc., that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid-state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

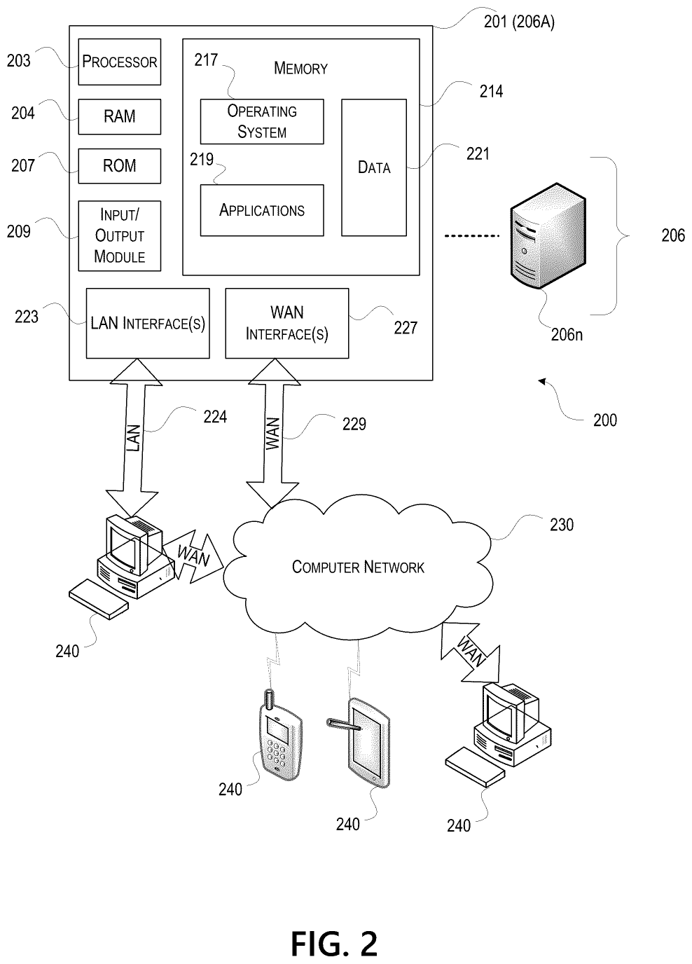

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server data center or single-server or multi-server desktop virtualization system (e.g., a remote access or cloud system) and can be configured to provide virtual machines for client access devices. The computing device 201 may have a processor 203 for controlling the overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special-purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as user devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.), including various other components, such as a battery, speaker, and antennas (not shown).

Aspects described herein may also be operational with numerous other general purpose or special-purpose computing system environments or configurations. Examples of other computing systems, environments, and/or configurations that may be suitable for use with aspects described herein include but are not limited to, personal computers, server computers, hand-held or laptop devices, multiprocessor systems, microprocessor-based systems, set-top boxes, programmable consumer electronics, network personal computers (PCs), minicomputers, mainframe computers, distributed computing environments that include any of the above systems or devices, and the like.

As shown in FIG. 2, one or more user devices 240 may be in communication with one or more data centers 206a-206n (generally referred to herein as “data center(s) 206”). In one embodiment, the computing environment 200 may include a network appliance installed between the data center(s) 206 and client machine(s) 240. The network appliance may manage client/server connections, and, in some cases, can load balance client connections amongst a plurality of backend data centers 206.

The client machine(s) 240 may, in some embodiments, be referred to as a single client machine 240 or a single group of client machines 240, while data center(s) 206 may be referred to as a single data center 206 or a single group of data centers 206. In one embodiment, a single client machine 240 communicates with more than one data center 206, while in another embodiment, a single data center 206 communicates with more than one client machine 240. In yet another embodiment, a single client machine 240 communicates with a single data center 206.

A client machine 240 can, in some embodiments, be referenced by any one of the following non-exhaustive terms: client machine(s); client(s); client computer(s); user device(s); client computing device(s); local machine; remote machine; client node(s); endpoint(s); or endpoint node(s). The data center 206, in some embodiments, may be referenced by any one of the following non-exhaustive terms: data center(s), local machine; remote machine; data center farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a data center 206 or a hypervisor executing on a client 240.

Some embodiments include a user device 240 that displays application output generated by an application remotely executing on a data center 206 or other remotely located machine. In these embodiments, the user device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The data center 206, in some embodiments, uses a remote presentation protocol or other program to send data to a thin-client or remote-display application executing on the client to present display output generated by a virtual application executing on the data center 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one data center 206a-206nsuch that the data centers 206a-206n are logically grouped together into a data center farm 206, for example, in a cloud computing environment. The data center farm 206 may include data centers 206 that are geographically dispersed while logically grouped together, or data centers 206 that are located proximate to each other while logically grouped together. Geographically dispersed data centers 206a-206n within a data center farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments, the data center farm 206 may be administered as a single entity, while in other embodiments, the data center farm 206 can include multiple data center farms.

In some embodiments, a data center farm may include data centers 206 that execute a substantially similar type of operating system platform (e.g., WINDOWS, UNIX, LINUX, iOS, ANDROID, etc.) In other embodiments, data center farm 206 may include a first group of one or more data centers that execute a first type of operating system platform, and a second group of one or more data centers that execute a second type of operating system platform.

Data center 206 may be configured as any type of data center, as needed, e.g., a file data center, an application data center, a web data center, a proxy data center, an appliance, a network appliance, a gateway, an application gateway, a gateway data center, a virtualization data center, a deployment data center, a Secure Sockets Layer (SSL) VPN data center, a firewall, a web data center, an application data center or as a master application data center, a data center executing an active directory, or a data center executing an application acceleration program that provides firewall functionality, application functionality, or load balancing functionality. Other data center types may also be used.

Some embodiments include a first data center 206a that receives requests from a client machine 240, forwards the request to a second data center 206b (not shown), and responds to the request generated by the client machine 240 with a response from the second data center 206b (not shown.) First data center 206a may acquire an enumeration of applications available to the client machine 240 as well as address information associated with an application data center 206 hosting an application identified within the enumeration of applications. First data center 206a can then present a response to the client's request using a web interface, and communicate directly with the client 240 to provide the client 240 with access to an identified application. One or more clients 240 and/or one or more data centers 206 may transmit data over network 230, e.g., network 101.

### Flexible Architecture for Providing Both Virtual and ZT Versions of an Application

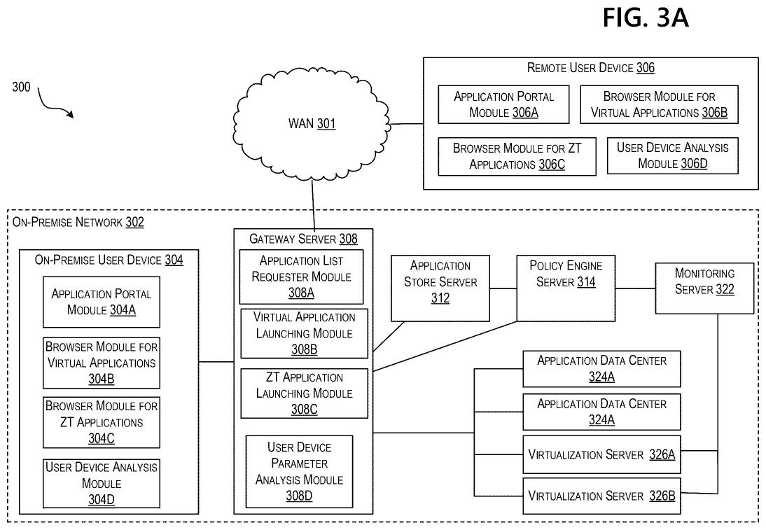

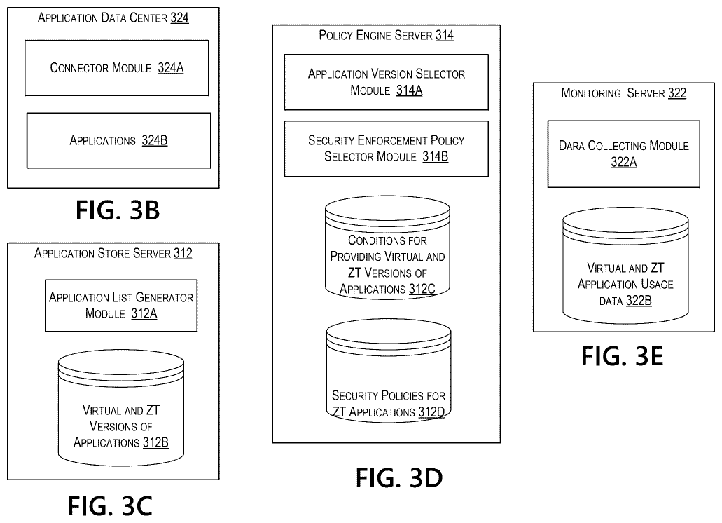

Referring to FIG. 3A, an illustrative computing environment, for dynamic provisions of virtual and ZT applications, is depicted. The computing environment 300 may include an on-premise user device 304, a remote user device 306, a gateway server 308, an application store server 312, a policy engine server 314, a monitoring server 322, application data centers 324A, 324A (collectively “application data centers 324”) , and/or virtualization servers 326A, 326B (collectively “virtualization servers 326”). While only one on-premise user device 304, one remote user device 306, one gateway server 308, one application store server 312, two application data centers 324, and two virtualization servers 326 are shown in FIG. 3A, any number of such devices may be implemented in the methods described herein without departing from the scope of the disclosure. The on-premise user device 304 and the remote user device 306 may also be alternatively described as the “user devices.”

The embodiment shown in FIG. 3A shows that the gateway server 308, the application store server 312, the policy engine server 314, the monitoring server 322, the application data centers 324, and the virtualization servers 326 are joined to the on-premise network 302 and also connected to each other via the premise network 302. Such an environment 300 may be known as an on-premise environment where the computing resources and systems of an organization are physically located within the organization's premises or facilities. Such an on-premise environment may give the organization direct control and ownership over its IT infrastructure, including the physical infrastructure, security measures, and network connectivity. On-premise environments may also offer lower latency as data processing and storage occur locally. Furthermore, there may be lower risks of third-party attacks, data breaches, data loss, and/or system downtime. The on-premise user device 304 may be physically located within the organization's premises or facilities, while the remote user device 306 may be outside the organization's premises or facilities.

Alternatively, aspects described herein may also be implemented in cloud-based environments where one or more of the application store server 312, the application data center 324, and the virtualization servers 326 may be outside the organization's premises or facilities and in a cloud service provider's data centers. Cloud-based environments may include and provide different types of cloud computing services, for example, Infrastructure as a service (IaaS), Platform as a service (PaaS), server-less computing, and/or Software as a service (SaaS). Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating systems, middleware, or runtime resources. In some embodiments, SaaS providers may offer additional resources including, e.g., data and application resources. Examples of SaaS include GOOGLE APPS provided by Google Inc., SALESFORCE provided by Salesforce. com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

The on-premise user device 304 may be in communication with one or more servers, such as the application store server 312, the application data centers 324, and/or the virtualization servers 326, via the on-premise network 302 (e.g., private intranets, corporate networks, local area networks (LAN), metropolitan area networks (MAN), wireless networks, personal networks (PAN), and the like). The on-premise user device 304 may be directly connected and/or joined to the private domain associated with the on-premise network 302, while the remote user device 306 may be connected to the private domain of the organization via only the WAN 301 or a combination of the WAN 301 and the on-premise network 302. The on-premise user device 304 and/or the remote user device 306 may communicate with the application store server 312, the application data centers 324,324, and/or the virtualization servers 325,326 via the gateway server 308. On-premises network 302 and/or WAN 301 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

The on-premise user device 304 and/or the remote user device 306 may be a personal computing device such as a smartphone, tablet, laptop computer, desktop computer, or the like. In some embodiments, the on-premise user device 304 and/or the remote user device 306 may be configured to facilitate the use of virtual desktops, virtual applications, and/or ZT applications. The on-premise user device 304 and/or the remote user device 306 various software components, such as an application portal module 304A, 306A, a browser module for virtual applications 304B, 306B, a browser module for ZT applications 304C, 304D, and/or a user device analysis module 304D, 306D. The application portal module 304A, 306A, when launched by a user, may send a request to the gateway server 308 or the application store server 312 for a list of applications available to the user associated with the user device, receive the list of available applications (e.g., either virtual versions, ZT versions, or a mix of virtual and ZT versions) from the gateway server 308 or the application store server 312, and/or display the list to the user. Upon selection of a virtual version of an application from the displayed list from the application portal module 304A, 306A, the browser module for virtual applications 304B, 306B may request initiation and/or execution of the virtual version of the application at one of the virtualization servers 326 to the gateway server 308. Upon selection of a ZT version of an application from the displayed list from the application portal module 304A, 306A, the browser module for ZT applications 304C, 306C may send a request to the gateway server 308 for authorization to initiate and/or execute the ZT version at the user device and access one of the application data centers 324 storing data files for the application. Upon receiving authorization to launch the ZT version, the browser module for ZT applications 304C, 306C may execute the ZT version on the user device. The browser module for ZT applications 304C, 306C may receive security policies for the ZT version from the gateway server 308 or the policy engine 314, and enforce the security policies while executing the ZT version of the application.

The user device analysis module 304D, 306D may be configured to determine parameters associated with the user device, such as the current configurations, status, and/or location of the user device. Such parameters may be used by the gateway server 308, the application store server 312, and/or the policy engine server 308 to choose an appropriate version of an application (e.g., a virtual version of the application to be executed at a virtualization server or a ZT version of the application to be executed locally at the user device) for the user device. In some embodiments, the user device analysis module 304D, 306D may be implemented as an Independent Computing Architecture (ICA) client developed by Citrix Systems, Inc. of Fort Lauderdale, FL. The user device analysis module 304D 306D may also perform end-point detection/scanning and collect end-point information about the user device for the gateway server 308, the policy engine server 314, and/or the monitoring server 322. The gateway server 308 and/or the policy engine server 314 may use the collected information to determine and provide access, authentication and authorization control of the user device's connection to the application data centers 324 and the virtualization servers 326. For example, the user device analysis module 304D, 306D may identify and determine one or more user device parameters, such as the operating system and/or a version of an operating system, a service pack of the operating system, a running service, a running process, a file, presence or versions of various applications of the client, such as antivirus, firewall, security, and/or other software, whether the user device has joined a private domain of the on-premise network 302, whether the user device is connected to a public network or a private network, such as a home network, whether the user device comprises a certificate associated with the private domain or organization, the physical location of the user device, etc.

User devices, such as the on-premise user device 304 and the remote user device 306, may include the functionality to communicate via on-premise network 302 and the WAN 301 with the gateway server 308. The user devices may communicate via the gateway server 308 and one or more secure tunnels to the application data centers 324, including to any one or more applications stored in the application data center. The user devices may also communicate via the gateway server 308 with the virtualization servers 326. The user devices may also include the functionality to resolve DNS requests for a particular application data center 350 or application DNS servers.

The user devices may include mobile applications, a desktop application or any other applications, such as the functionality to communicate with applications on other devices, such as applications stored in the application data centers 324, the virtualization servers 326, or other network services or devices. Such applications may include, for example, a streaming audio or video application, a secure shell application, a remote desktop application, an email application or any other application that can utilize or generate network traffic. The user devices may run any number of applications, which can communicate with any other number of applications on any other number of same or different data centers or virtualization servers and via any number of same or different gateway servers 308.

Application data centers 324 may be logically grouped, and may either be geographically co-located (e.g., on-premises) or geographically dispersed (e.g., different premises or cloud based). Referring to FIG. 3B, each application data center 324 may include a connector module 324A and/or one or more applications 324B. The connector module 324A may include any device, function, hardware or a combination of hardware and software for managing and routing network traffic to and from a user device and the application data center. The connector module 324A may receive, encapsulate and/or decapsulate, encrypt and/or decrypt the data transmitted between user devices and the application data centers. The connector module 324A may include the functionality for creating and maintaining dedicated tunnels between the user device and the data center for secure data transmission. Applications 324B may include any hardware, software, combination of hardware and software and computer program, code and/or instructions stored in memory and implemented in one or more processors.

A tunnel may include a secured connection between two or more devices, such as a user device and an application data center. A tunnel may include ZTNA protocols that allow for secure movement of data from one network to another or from one device to another device. A tunnel may include a secured communication connection/link/session established via the on-premise network 302 and/or WAN 301. A tunnel may include a direct communication connection/link/session without any intervening or intermediary devices or services. A tunnel may include a communication connection/link/session via one or more intervening or intermediary devices or services, such as the gateway server 308. A tunnel can include an IPsec tunnel, a dynamic multipoint VPN or aMPLS-based L3VPN.

Applications 324B can include an application accessed remotely via a dedicated tunnel enforcing ZTNA protocols by a browser module for ZT applications in a user device or by a virtual machine in a virtualization server. Applications 324B may include, for example, secured file storage, confidential information, streaming audio or video application(s), one or more secure shell applications, one or more remote desktop applications, one or more email applications or any other application that can utilize or generate network traffic. The data center may run any number of applications 324B of the same or a different type or instance.

Referring back to FIG. 3A, the computing environment 300 may also comprise an application store server 312 for delivering various versions (e.g., virtual or ZT) of different applications to user devices. The data files for the various versions of the applications may be stored in database 312B, as illustrated in FIG. 3C. The application store server 312 may comprise various software components, such as the application list generator module 312A, that may deliver virtual and/or ZT versions of applications via the gateway server 308. The application list generator module 312A may deliver various versions of the applications to user devices, remote or on-premise, based on authentication and authorization policies applied by the policy engine server 314. The list of applications may be delivered via an application stream, or via a remote-display protocol or otherwise via remote-based or server-based computing. In an embodiment, the application store server 312 may be implemented as any portion of the Citrix Workspace Suite™ by Citrix Systems, Inc., such as Citrix Virtual Apps and Desktops (formerly XenApp® and XenDesktop®).

Referring back to FIG. 3A, the policy engine server 314 may control and manage the access to, and execution and delivery of, applications to the on-premise user device and/or the remote user device. The policy engine server 314 may comprise various software components, such as an application version selector module 314A and a security enforcement selector module 314B, as illustrated in FIG. 3D. The application version selector module 314A may determine which applications a user device is authorized to access and/or how the application should be delivered to the user device, such as delivering a virtual version for execution in virtualization servers or delivering the ZT version of the application locally to the user device for local execution. The security enforcement selector module 314B may control and manage security policies to be enforced on ZT versions of applications being executed on user devices. The security policies may include security controls at the HTTP level. For example, security policies may include restricting clipboard access, printing, downloading, capturing screenshots, keystroke logging, access to internal servers joined to a private domain, access to servers external to the private domain, etc. The policy engine server 314 may also include a database 312C for storing predetermined conditions for providing either virtual or ZT versions of applications and/or a database 312D for security policies for different ZT versions of applications.

Referring back to FIG. 3A, gateway servers, such as the gateway server 308, may be located at various points or in various communication paths of the on-premises network 302. The gateway server 308 may be and/or comprise one or more computing devices (e.g., a server, gateway, router, switch, bridge or other types of computing or network device, or the like), appliances, or the like configured to function as a network gateway between the user devices and other servers, such as the application store server, the policy engine server, the application data center, virtualization servers. The gateway server 308 can include an interface for exchanging network traffic between the on-premise network 302 and the WAN 301. The gateway server 308 may include an internet exchange point (IXP) or a colocation center. The application store server 312, the policy engine server 314, application data centers 324, and/or virtualization servers 326 may communicate with the user devices via the gateway server 308. Additionally, the user devices may communicate with the other servers via the gateway server. In other embodiments, the gateway server 308 may be located on the on-premise network 302, as shown in FIG. 3A. In an embodiment, the gateway server 308 may be implemented as a network device such as Citrix networking (formerly NetScaler®) products sold by Citrix Systems, Inc. of Fort Lauderdale, FL. The gateway server 308 may comprise various software components, such as an application list requester module 308A, a virtual application launching module 308B, a ZT application launching module 308C, and/or a user device parameter analysis module 308D.

The application list requester module 308A may receive a request from a user device (e.g., the on-premise user device 304 or the remote user device 306) and facilitate delivery of available applications to user devices, for example, from the application store server 312 and/or application data centers 324. The user device parameter analysis module 308B may send a request to the user device to send user device parameters that would be used to determine which applications should be made available to the user device and which version of an application (e.g., virtual or ZT) should be provided to the user device.

The virtual application launching module 308B may receive a request from a user device (e.g., the on-premise user device 304 or the remote user device 306) to initiate the execution of a virtual version of an application. The virtual application launching module 308B may select a virtualization server for the user device (e.g., one of the virtualization servers 326) and send a request to the selected virtualization server to initiate a virtual machine and execute the virtual version of the user device on the virtual machine. The virtual application launching module 308B may facilitate data transmission between the user device and the virtual machine.

The ZT application launching module 308C may receive a request from a user device (e.g., the on-premise user device 304 or the remote user device 306) to initiate the execution of a ZT version of an application. Along with the request, the browser module for ZT applications 308C may also request and receive user device parameters (e.g., the current device and network configurations and/or location of the user device), user credentials, and/or device credentials. The ZT application launching module 308C may forward the launch request, the user device parameters, the user credentials, and/or the device credentials to the policy engine server 314 and request the policy engine server 314 to authorize the user device to initiate execution of the ZT version. If the policy engine server 314 authorizes the user device, the ZT application launching module 308C may select one of the application data centers 324 storing data files for the ZT version and initiate creating a secured tunnel between the selected application data center and the user device. The dedicated tunnel may include a protocol that allows for secure movement of data between the selected application data center and the user device.

The virtual application launching module 308B and/or the ZT application launching module 308C may also provide load balancing of the virtualization servers and/or application data centers to process requests from user devices, act as a proxy or access server to provide access to the virtualization servers and/or application data centers, provide security and/or act as a firewall between the user devices and the virtualization servers and/or application data centers, provide Domain Name Service (DNS) resolution, provide one or more virtual servers or virtual internet protocol servers, and/or provide a secure virtual private network (VPN) connection from a user device to one of the virtualization servers and/or application data centers, such as a secure socket layer (SSL) VPN connection and/or provide encryption and decryption operations. In some embodiments, gateway server 308 may use a tunneling protocol to provide a Virtual Private Network (VPN) between a user device and one of the virtualization servers and/or application data centers.

Referring back to FIG. 3A, in some embodiments, a monitoring server 322 may be employed to perform performance monitoring of virtual and/or ZT versions of applications. Performance monitoring may be performed using data collection, aggregation, analysis, management and reporting, for example, by software, hardware or a combination thereof. Referring to FIG. 3E, the monitoring server 322 may include software components, such as a data collecting module 322A, and/or one or more databases, such as the database 322B, for storing virtual and ZT application usage data. The data collecting module 322A may include one or more agents for performing monitoring, measurement and data collection on activities by virtual versions of applications on the virtualization servers 326 and/or on activities of ZT versions of applications from the policy engine server 322. The collected data by the data collecting module 322A may be stored in the database 322B. In some embodiments, the monitoring server 322 may be implemented by any of the product embodiments referred to as Citrix Analytics or Citrix Application Delivery Management by Citrix Systems, Inc. of Fort Lauderdale, FL.

The data collecting module 322A may monitor, collect, and/or analyze data on the usage of virtual and/or ZT applications by the on-premise user device 302 and/or the remote user device 306. The data collecting module 322A may monitor resource consumption and/or performance of hardware, software, and/or communications resources of the user devices, on-premise network 302, launched virtual versions of applications in virtualization servers, and/or requests for authorizations to use ZT versions of applications from the policy engine server 314. Based on the collected data, network administrators may modify the predetermined conditions for the ZT and virtual versions of the applications and/or the security policies for ZT versions in the policy engine server.

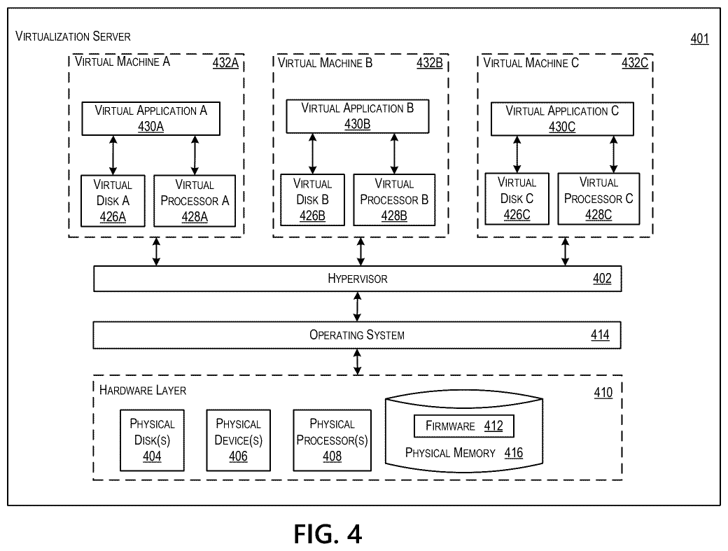

FIG. 4 depicts an illustrative virtualization server 401 (e.g., the virtualization servers 324) that may be used in accordance with one or more illustrative aspects described herein. As shown, the virtualization server 401 may be single-server or multi-server system, or cloud system, configured to provide virtual applications to one or more on-premise user devices (e.g., on-premise user device 304) and/or one or more remote user devices (e.g., remote user device 306). Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

Virtualization server 401 illustrated in FIG. 4 can be deployed as and/or implemented by one or more embodiments of the server 206 illustrated in FIG. 2, the virtualization servers 326 in FIG. 3, or by other known computing devices. Included in virtualization server 401 is a hardware layer that can include one or more physical disks 404, one or more physical devices 406, one or more physical processors 408, and one or more physical memories 416. In some embodiments, firmware 412 can be stored within a memory element in the physical memory 416 and can be executed by one or more of the physical processors 408. Virtualization server 401 may further include an operating system 414 that may be stored in a memory element in the physical memory 416 and executed by one or more of the physical processors 408. Still further, a hypervisor 402 may be stored in a memory element in the physical memory 416 and can be executed by one or more of the physical processors 408.

Executing on one or more of the physical processors 408 may be one or more virtual machines 432A-C (generally 432). Each virtual machine 432 may have a virtual disk 426A-C and a virtual processor 428A-C. In some embodiments, one or more virtual machines 432B-C can execute, using a virtual processor 428B-C, virtual applications 430A-B.

Virtualization server 401 may include a hardware layer 410 with one or more pieces of hardware that communicate with the virtualization server 401. In some embodiments, the hardware layer 410 can include one or more physical disks 404, one or more physical devices 406, one or more physical processors 408, and/or one or more physical memory 416. Physical components 404, 406, 408, and 416 may include, for example, any of the components described above. Physical devices 406 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 401. Physical memory 416 in the hardware layer 410 may include any type of memory. Physical memory 416 may store data, and in some embodiments may store one or more programs, or set of executable instructions. FIG. 4 illustrates an embodiment where firmware 412 is stored within the physical memory 416 of virtualization server 401. Programs or executable instructions stored in the physical memory 416 can be executed by the one or more processors 408 of virtualization server 401.

Virtualization server 401 may also include a hypervisor 402. In some embodiments, hypervisor 402 may be a program executed by processors 408 on virtualization server 401 to create and manage any number of virtual machines 432. Hypervisor 402 may be referred to as a virtual machine monitor, or platform virtualization software. In some embodiments, hypervisor 402 can be any combination of executable instructions and hardware that monitors virtual machines executing on a computing machine. Hypervisor 402 may be Type 2 hypervisor, where the hypervisor executes within an operating system 414 executing on the virtualization server 401. Virtual machines may then execute at a level above the hypervisor 402. In some embodiments, the Type 2 hypervisor may execute within the context of a user's operating system such that the Type 2 hypervisor interacts with the user's operating system. In other embodiments, one or more virtualization servers 401 in a virtualization environment may instead include a Type 1 hypervisor (not shown). A Type 1 hypervisor may execute on the virtualization server 401 by directly accessing the hardware and resources within the hardware layer 310. That is, while a Type 2 hypervisor 402 accesses system resources through a host operating system 414, as shown, a Type 1 hypervisor may directly access all system resources without the host operating system 414. A Type 1 hypervisor may execute directly on one or more physical processors 408 of virtualization server 401, and may include program data stored in the physical memory 416.

Hypervisor 402, in some embodiments, can provide virtual resources to virtual applications 430 executing on virtual machines 432 in any manner that simulates the virtual applications 430 having direct access to system resources. System resources can include, but are not limited to, physical devices 406, physical disks 404, physical processors 408, physical memory 416, and any other component included in hardware layer 410 of the virtualization server 401. Hypervisor 402 may be used to emulate virtual hardware, partition physical hardware, virtualize physical hardware, and/or execute virtual machines that provide access to computing environments. In still other embodiments, hypervisor 402 may control processor scheduling and memory partitioning for a virtual machine 432 executing on virtualization server 401. Hypervisor 402 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 401 may be referred to as a host server. An example of such a virtualization server is the Citrix Hypervisor provided by Citrix Systems, Inc., of Fort Lauderdale, FL.

Hypervisor 402 may create one or more virtual machines 432B-C (generally 432) in which virtual applications 430 execute. In some embodiments, hypervisor 402 may load a virtual machine image to create a virtual machine 432. In other embodiments, the hypervisor 402 may execute a virtual application 430 within virtual machine 432. In other embodiments, virtual machine 432 may execute virtual application 430.

In addition to creating virtual machines 432, hypervisor 402 may control the execution of at least one virtual machine 432. In other embodiments, hypervisor 402 may present at least one virtual machine 432 with an abstraction of at least one hardware resource provided by the virtualization server 401 (e.g., any hardware resource available within the hardware layer 410). In other embodiments, hypervisor 402 may control the manner in which virtual machines 432 access physical processors 408 available in virtualization server 401. Controlling access to physical processors 408 may include determining whether a virtual machine 432 should have access to a processor 408, and how physical processor capabilities are presented to the virtual machine 432.

As shown in FIG. 4, virtualization server 401 may host or execute one or more virtual machines 432. A virtual machine 432 is a set of executable instructions that, when executed by a processor 408, may imitate the operation of a physical computer such that the virtual machine 432 can execute programs and processes much like a physical computing device. While FIG. 4 illustrates an embodiment where a virtualization server 401 hosts three virtual machines 432, in other embodiments, the virtualization server 401 can host any number of virtual machines 432. Hypervisor 402, in some embodiments, may provide each virtual machine 432 with a unique virtual view of the physical hardware, memory, processor, and other system resources available to that virtual machine 432. In some embodiments, the unique virtual view can be based on one or more of virtual machine permissions, the application of a policy engine to one or more virtual machine identifiers, a user accessing a virtual machine, the applications executing on a virtual machine, networks accessed by a virtual machine, or any other desired criteria. For instance, hypervisor 402 may create one or more unsecure virtual machines 432 and one or more secure virtual machines 432. Unsecure virtual machines 432 may be prevented from accessing resources, hardware, memory locations, and programs that secure virtual machines 432 may be permitted to access. In other embodiments, hypervisor 402 may provide each virtual machine 432 with a substantially similar virtual view of the physical hardware, memory, processor, and other system resources available to the virtual machines 332.

Each virtual machine 432 may include a virtual disk 426A-C (generally 426) and a virtual processor 428A-C (generally 428.) The virtual disk 426, in some embodiments, may be a virtualized view of one or more physical disks 404 of the virtualization server 401, or a portion of one or more physical disks 404 of the virtualization server 401. The virtualized view of the physical disks 404 can be generated, provided, and managed by the hypervisor 402. In some embodiments, hypervisor 402 provides each virtual machine 432 with a unique view of the physical disks 404. Thus, in these embodiments, the particular virtual disk 426 included in each virtual machine 432 can be unique when compared with the other virtual disks 426.

A virtual processor 428 can be a virtualized view of one or more physical processors 408 of the virtualization server 401. In some embodiments, the virtualized view of the physical processors 408 can be generated, provided, and managed by hypervisor 402. In some embodiments, virtual processor 428 has substantially all of the same characteristics of at least one physical processor 408. In other embodiments, virtual processor 408 provides a modified view of physical processors 408 such that at least some of the characteristics of the virtual processor 428 are different than the characteristics of the corresponding physical processor 408.

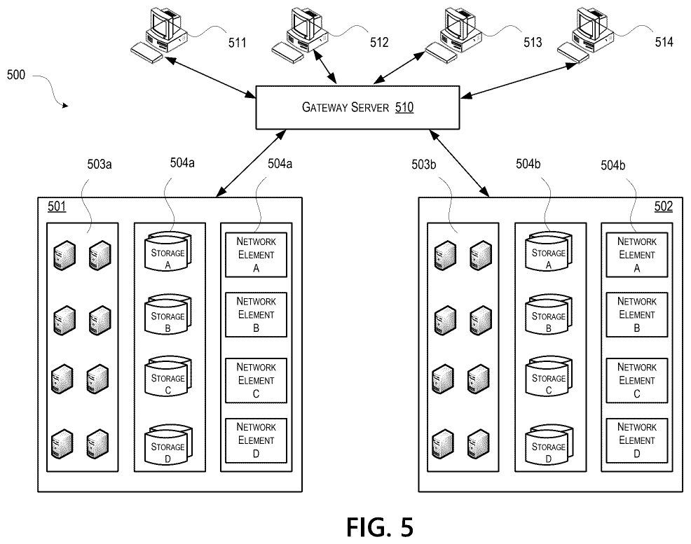

With further reference to FIG. 5, some aspects described herein may be implemented in an on-premise environment (e.g., the on-premise environment 300 in FIG. 3) or a cloud-based environment. As seen in FIG. 5, user devices 511-514 (e.g., the on-premise user device 304 and/or the remote user device 306) may communicate with a gateway server 510 (e.g., the gateway server 308) to access the computing resources (e.g., host servers 503a-503b(generally referred herein as “host servers 503”), storage resources 504a-504b (generally referred herein as “storage resources 504”), and network elements 505a-505b (generally referred herein as “network resources 505”)) of the cloud system.

The gateway server 510 (e.g., the gateway server 308) may be implemented on one or more physical servers. Gateway server 510 may manage various computing resources, including hardware and software resources, for example, host computers 503, data storage devices 504, and networking devices 505. The hardware and software resources may include private and/or public components. For example, the hardware and software resources may form a cloud that may be configured as a private cloud to be used by one or more particular customers or client computers 411-414 and/or over a private network (e.g., the on-premise network 302). In other embodiments, public clouds or hybrid public-private clouds may be used by other customers over an open or hybrid networks.

Gateway server 510 may be configured to provide user interfaces through which operators and customers may interact with the system 500. For example, the gateway server 510 may provide a set of application programming interfaces (APIs) and/or one or more operator console applications (e.g., web-based or standalone applications) with user interfaces to allow operators to manage the resources, configure the virtualization layer, manage customer accounts, and perform other administration tasks. The gateway server 510 also may include a set of APIs and/or one or more customer console applications with user interfaces configured to receive computing requests from end users via user devices 511-514, for example, requests to create, modify, or destroy virtual machines within the virtualization servers, provide application portals to the user devices, and/or enable connections of ZT applications in user devices 511-514 to host servers 503a-503b implementing application data centers (e.g., application data center 324). User devices 511-514 may connect to gateway server 510 via the Internet or some other communication network, and may request access to one or more of the computing resources managed by gateway server 510. In response to client requests, the gateway server 510 may include a resource manager configured to select and provision physical resources based on the client requests. For example, the gateway server 510 may be configured to provision, create, and manage virtual machines and their operating environments (e.g., hypervisors, storage resources, services offered by the network elements, etc.) for customers at user devices 511-514, over a network (e.g., the Internet), providing customers with computational resources, data storage services, networking capabilities, and computer platform and application support. The gateway server 510 may also be configured to provision applications available to user devices 511-514 from application stores (e.g., the application store server 312). Additionally, the gateway server 510 may be configured to provision secure dedicated tunnels between ZT applications running on user devices 511-514 to application data centers 324 hosting applications.

Certain user devices 511-514 may be related, for example, to different client computers creating virtual machines on behalf of the same end user, or different users affiliated with the same company or organization. In other examples, certain user devices 511-514 may be unrelated, such as users affiliated with different companies or organizations. For unrelated clients, information on the virtual machines or storage of any one user may be hidden from other users.

Referring now to the physical hardware layer of the computing environment 300, availability zones 501-502 (or zones) may refer to a collocated set of physical computing resources. Zones may be geographically separated from other zones. For example, zone 501 may be a first data center located in California, and zone 502 may be a second data center located in Florida. Gateway server 510 may be located at one of the availability zones, or at a separate location. Each zone may include an internal network that interfaces with devices that are outside of the zone. User devices 511-514 might or might not be aware of the distinctions between zones. For example, an end user may request the creation of a virtual machine having a specified amount of memory, processing power, and network capabilities. The gateway server 510 may respond to the user's request and may allocate the resources to create the virtual machine without the user knowing whether the virtual machine was created using resources from zone 501 or zone 502. In other examples, the gateway server 510 may allow end users to request that virtual machines (or other cloud resources) are allocated in a specific zone or on specific resources 503-505 within a zone.

In this example, each zone 501-502 may include an arrangement of various physical hardware components (or computing resources) 503-505, for example, physical hosting resources (or processing resources), physical network resources, physical storage resources, switches, and additional hardware resources that may be used to provide computing services to customers. The physical hosting resources in a zone 501-502 may include one or more computer servers 503, such as the virtualization servers 324, 401 described above, which may be configured to create and host virtual machine instances, or data centers, such as the application data center 326. The physical network resources in a zone 501 or 502 may include one or more network elements 505 (e.g., network service providers) comprising hardware and/or software configured to provide a network service to customers, such as firewalls, network address translators, load balancers, virtual private network (VPN) gateways, Dynamic Host Configuration Protocol (DHCP) routers, and the like. The storage resources in the zone 501-502 may include storage disks (e.g., solid state drives (SSDs), magnetic hard disks, etc.) and other storage devices.

The example computing environment shown in FIG. 5 may also include a virtualization layer (e.g., as shown in FIG. 4) with additional hardware and/or software resources configured to create and manage virtual machines and provide other services to customers. The virtualization layer may include hypervisors, as described above in FIG. 4, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 404 with the physical computing resources. Known cloud systems may alternatively be used, e.g., WINDOWS AZURE (Microsoft Corporation of Redmond Washington), AMAZON EC2 (Amazon. com Inc. of Seattle, Washington), IBM BLUE CLOUD (IBM Corporation of Armonk, New York), or others.

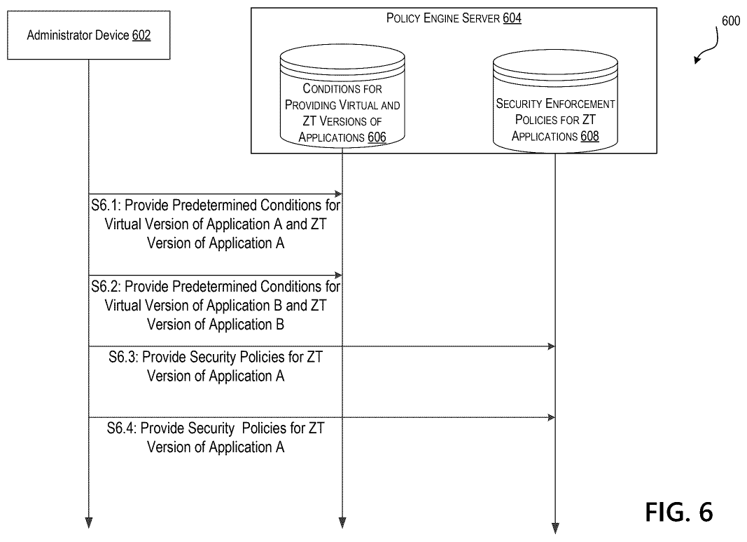

FIG. 6 depicts an illustrative event sequence 600 illustrating a method for providing predetermined conditions for the provision of ZT and virtual versions of applications and security policies for ZT applications to a policy engine server 604 (e.g., the policy engine server 314) in accordance with one or more illustrative aspects described herein. The actions in the event sequence 600 may be performed in different orders and with different, fewer, or additional actions than those illustrated in FIG. 6. Multiple actions can be combined in some implementations.

The event sequence 600 may begin at step S6.1, where an administrator device 602 (e.g., a user device belonging to a network administrator of the on-premise network 302 of an organization) may use administrative privilege to provide predetermined conditions that user devices (e.g., on-premise user device 304, remote user device 306) need to meet to receive a virtual version of application A and/or predetermined conditions that the user devices need to be met in order to receive a ZT version of application A to a policy engine server 604 (e.g., policy engine server 314). For example, the administrator device 602 may send data indicating that the ZT version of application A will only be provided to a user device if the user device is connected to the private network of the organization via an ethernet port available at the premises of the organization, the user device is present at the premises of the organization and the user device is running an anti-virus application. Otherwise, a virtual version of application A will be provided to the user device. The predetermined conditions for application A may be saved by the policy engine server 604 in the conditions for providing virtual and ZT versions of applications database 606.

At step S6.2, the administrator device 602 may provide predetermined conditions that user devices need to meet to receive a virtual version of application B and/or predetermined conditions that the user devices need to meet in order to receive a ZT version of application B to a policy engine server 604. The predetermined conditions for application B may be different than the predetermined conditions of application A. For example, the administrator device 602 may send data indicating that the ZT version of application B may be provided to a user device if the user device is running an anti-virus application and that no other requirements are needed. The data may further indicate that if the user device is not running an anti-virus application, then a virtual version of Application B will be provided to the user device. The predetermined conditions for application B may be saved by the policy engine server 604 in the conditions for providing virtual and ZT versions of applications database 606.

At step S6.3, the administrator device 602 may provide security policies that need to be enforced in user devices (e.g., enforced by the browser module for ZT applications 304C, 306C) if the user device is executing the ZT version of application A. For example, the administrator device 602 may provide data to the policy engine server 604, where the data indicates that downloading files and capturing screenshots while using the ZT version of application A need to be restricted. The security policies for the application A may be saved by the policy engine server 604 in the security enforcement policies for ZT applications database 608. At step S6.4, the administrator device 602 may provide security policies that need to be enforced in user devices (e.g., enforced by the browser module for ZT applications 304C, 306C) if the user device is executing the ZT version of application B. The security policies of application B may be different than the security policies of application A. For example, the security policies for application B may indicate restrictions in accessing servers outside the private domain. The security policies for application B may be saved by the policy engine server 604 in the security enforcement policies for ZT applications database 608.

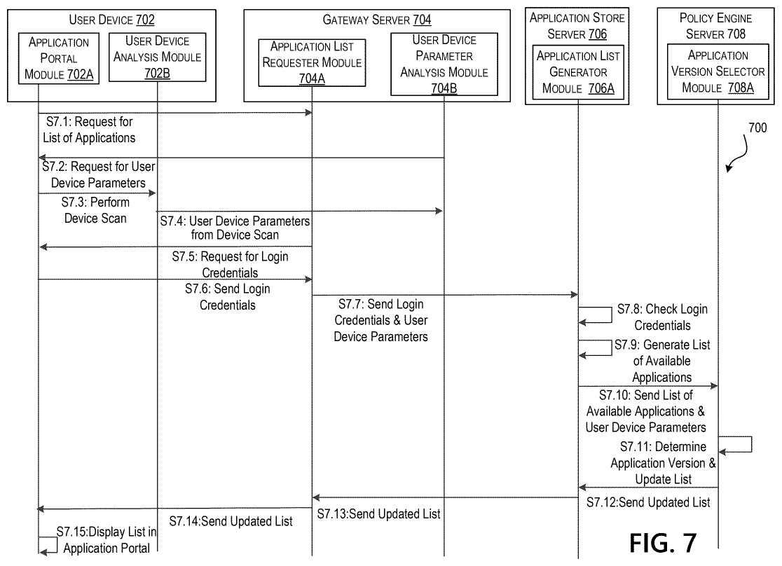

FIG. 7 depicts an illustrative event sequence 700 for providing a user device 702 (e.g., the on-premise user device 304 or the remote user device 306) with a list of available applications in accordance with one or more illustrative aspects described herein. The actions in the event sequence 700 may be performed in different orders and with different, fewer, or additional actions than those illustrated in FIG. 7. Multiple actions can be combined in some implementations.

The event sequence 700 may begin at step S7.1, where the application portal module 702A of the user device 702 may send a request for a list of applications to the gateway server 704 (e.g., the gateway server 308). The user device 702 may automatically send this request when a user of the user device 702 launches the application portal module 702A. At step S7.2, the gateway server, based on receiving the request at S7.1, may request one or more parameters associated with the user device 702 from the user device 702. The requested parameters may be associated with the network configurations, device configurations, and/or location of the user device 702 (e.g., the operating system and/or a version of an operating system, a service pack of the operating system, a running service, a running process, a file, presence or versions of various applications of the client, such as antivirus, firewall, security, and/or other software, whether the user device has joined a private domain of the on-premise network 302, whether the user device is connected to a public network or a private network, such as a home network, whether the user device comprises a certificate associated with the private domain or organization, the physical location of the user device, etc.). At step S7.3, the application portal module 702A of the user device 702 may send a request to the user device analysis module 702B of the user device 702 to perform a device scan to determine the user device parameters requested by the gateway server 704 and send the parameters to the user device parameter analysis module 704B of the gateway parameter 704. At step S7.4, the user device analysis module 702B of the user device 702 may send the requested user device parameters to the application list requester module 704A of the gateway server 704.

At step S7.5, the application list requester module 704A of the gateway server 704 may send a request to the user device 702 for login credentials of the user of the user device 702 to the application portal module 702A of the user device 702. The request may comprise information for password-based authentication, two-factor/multifactor authentication, biometric authentication, single sign-on, token-based authentication, certificate-based authentication, and the like. At step S7.6, the application portal module 702A of the user device 702 may send the requested login credentials to the application list requester module 704A of the gateway device 704.

At step S7.7, the application list requester module 704A of the gateway server 704 may send the login credentials received at step S7.6 and the user device parameters received at step S7.4 to the application list generator module 706A of the application store server 706 (e.g., the application store server 312). At step S7.8, the application list generator module 706A checks the login credentials to determine whether the user device 702 is authorized to access applications from the application store server 706. At step S7.9, the application list generator module 706A may generate a list of available applications that the user device 702 is authorized to access based on the login credentials of the user device 702. At step S7.10, the application list generator module 706A sends the list of available applications and the user device parameters of the user device 702 to the application version selector module 708A of the policy engine server 708 (e.g., the policy engine server 314).

At step S7.11, the application version selector module 708A determines which applications in the list of applications may be provided as virtual versions and/or which applications in the list of applications may be provided as ZT versions based on the user device parameters. For example, the application version selector module 708A may store predetermined conditions for virtual and ZT applications provided by network administrators and determine the version of each application based on whether the user device parameters meet the predetermined conditions. The application version selector module 708A may update the list of applications to indicate which applications should be provided as virtual versions of the applications and which applications should be provided as ZT versions. At step 7.12, the updated list may be sent to the application list generator module 706A of the application store server 706 by the application version selector module 708A of the policy engine server 708. At step 7.13, the list generator module 706A may gather data files of the different versions of the applications suggested by the application version selector module 708A and send the updated list of applications and the data files to the application list requester module 704A of the gateway server 704. The updated list of applications and the data files may then be forwarded to the application portal module 702A of the user device 702 at step S7.14 by the application list requester module 704A. At step S7.15, the application portal module 702A may display the list via a user interface or an application portal.

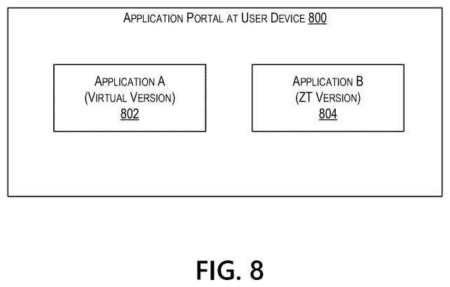

The displayed list may only include virtual versions or only include ZT versions. In some embodiments, the displayed list may include a mix of virtual versions and ZT versions. For example, in the illustrative application portal 800 in FIG. 8A, two applications, application A and application B, may be displayed. The link 802 for application A may launch a virtual version of application A, while the link 804 for application B may launch a ZT version of application B. In some embodiments, the application portal 800 may not display which version of the application is provided to the user device.

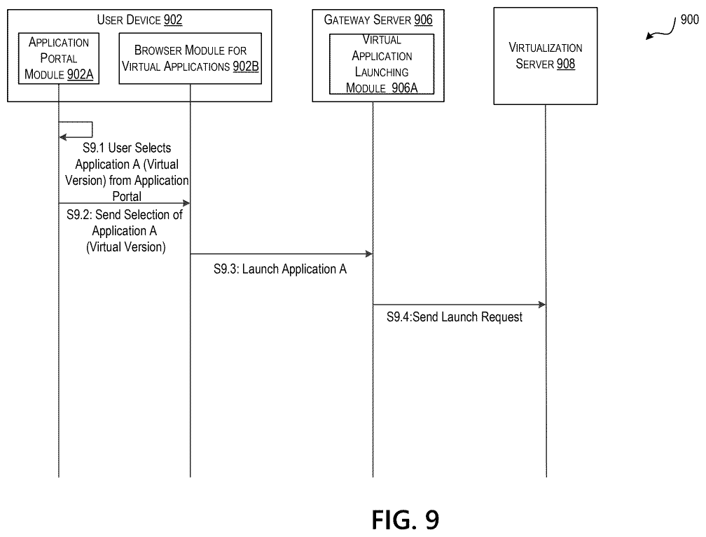

FIG. 9 depicts an illustrative event sequence 900 for launching a virtual version of an application by a user device (e.g., the on-premise user device 304 or the remote user device 306) in accordance with one or more illustrative aspects described herein. The actions in the event sequence 900 may be performed in different orders and with different, fewer, or additional actions than those illustrated in FIG. 9. Multiple actions can be combined in some implementations.

At step S9.1, the application portal module 902A of the user device may receive a signal indicating that a user of the user device has selected a virtual version of application A (e.g., application A 802 in application portal 800) for launching. At step S9.2, the application portal module 902A may send the request to the browser module for virtual applications 902B of the user device 902. At step S9.3, the browser module for virtual applications 902B may send a request to the virtual application launching module 906A of the gateway server 906 (e.g., the gateway server 308) to launch application A in a virtual machine in a virtualization server. At step S9.4, the virtual application launching module 906A may select a virtualization server 908 (e.g., one of the virtualization servers 326) and send the request to the selected virtualization server 908.

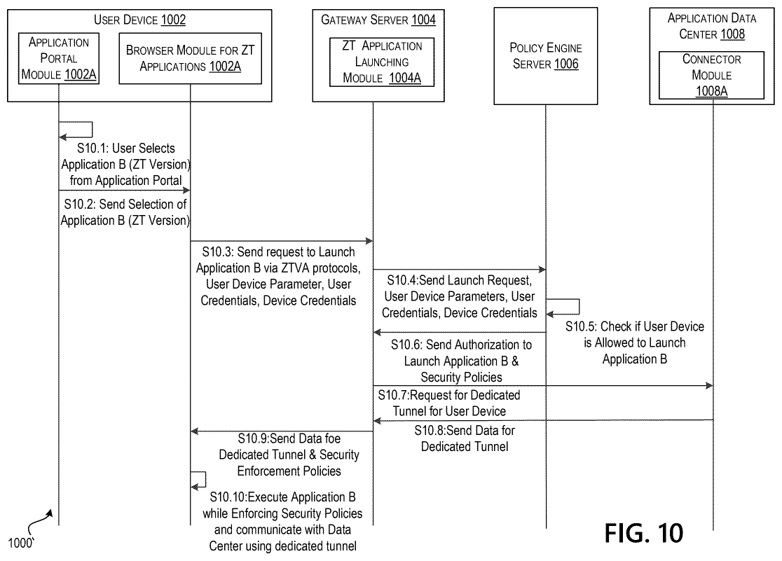

FIG. 10 depicts an illustrative event sequence 1000 for launching a ZT version of application B (e.g., application B 804 in application portal 800) in accordance with one or more illustrative aspects described herein. The actions in the event sequence 1000 may be performed in different orders and with different, fewer, or additional actions than those illustrated in FIG. 10. Multiple actions can be combined in some implementations.

At step S10.1, the application portal module 1002A of the user device 1002 (e.g., the on-premise user device 304 or the remote user device 306) may receive a signal indicating that a user of the user device has selected a ZT version of application B (e.g., application B 804 in application portal 800) for launching. At step S10.2, the application portal module 1002A may send the request to the browser module for ZT applications 1002B of the user device 1002. At step S10.3, the browser module for ZT applications 1002B may send a request to the ZT application launching module 1004A of the gateway server 1004 (e.g., the gateway server 308) to launch application B. Along with the request to launch application B, the browser module for ZT applications 1002B may also send user device parameters (e.g., the current device and network configurations and/or location of the user device 1002), user credentials and/or device credentials to the ZT application launching module 1004A.

At step S10.4, the ZT application launching module 1004A may forward the launch request, the user device parameters, the user credentials, and/or the device credentials to the policy engine server 1006 (e.g., the policy engine server 314). At step S10.5, the policy engine server 1006 may determine whether the user device 1002 is authorized to launch the ZT version of Application B. The policy engine server 1006 may validate the user credentials and/or the device credentials to authorize the user device 1002 to launch the ZT version of Application B. Authorizing the user device 1002 may further include checking whether the user device parameters meet the predetermined conditions for launching ZT version of Application B at the user device 1002. At step 10.6, if the policy engine server 1006 authorizes the user device 1002 to launch the ZT version of Application B, the policy engine server 1006 may send data to the ZT application launching module 1004A of the gateway server 1004 indicating that the user device is authorized to launch the ZT version of Application B. Additionally, the policy engine server 1006 may send security policies that the browser module for ZT applications 1002B should enforce while running the ZT version of Application B.

At step 10.7, the policy engine server 1006 may select an application data center 1008 (e.g., select one of the application data centers 324) storing data files for the ZT version of Application B and send a request to the connector module 1008A of the application data center 1008 to create a secured tunnel between the data center 1008 and the user device 1002. The dedicated tunnel may include ZTNA protocols that allow for secure movement of data between the data center 1008 and the user device 1002. The dedicated tunnel may include a secured communication connection/link/session established via a private network (e.g., the on-premise network 302) and/or a WAN (e.g., WAN 301). At step S10.2, the data center 1008 may create the tunnel and send data about the dedicated tunnel to the ZT application launching module 1004A of the gateway server 1004. At step S10.9, the ZT application launching module 1004A may send the data about the dedicated tunnel received at step 10.8 and the security policies received at step S10.6 to the browser module for ZT applications 1002B of the user device 1002. At step S10.10, the browser module for ZT applications 1002B executes the ZT version of application B while enforcing the security policies on application B and transmitting data with the Application data center 1008 via the dedicated tunnel.

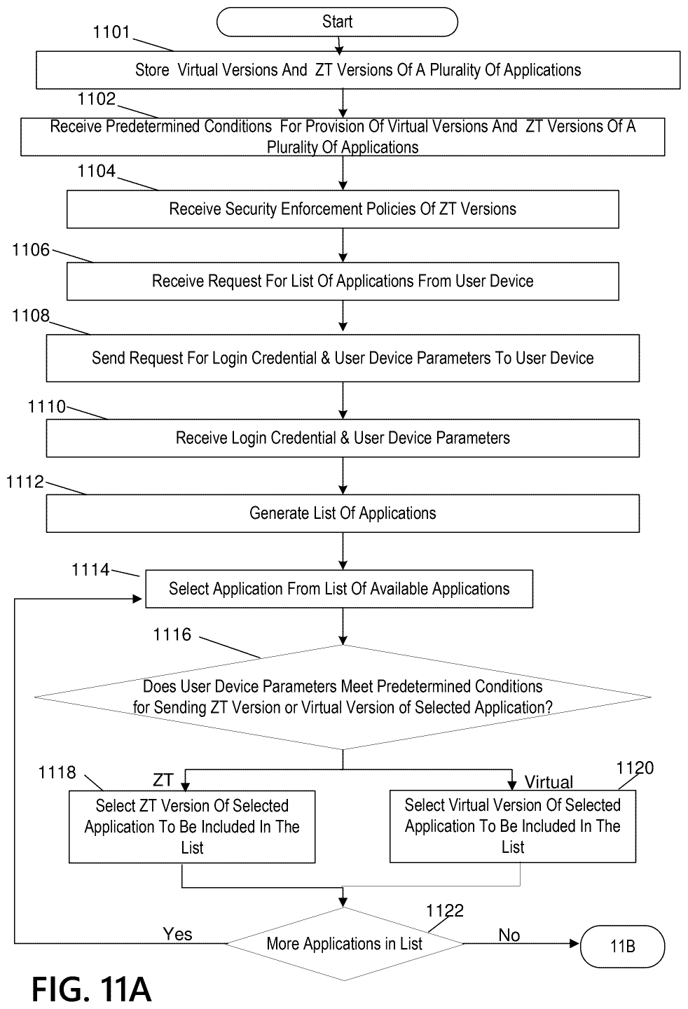

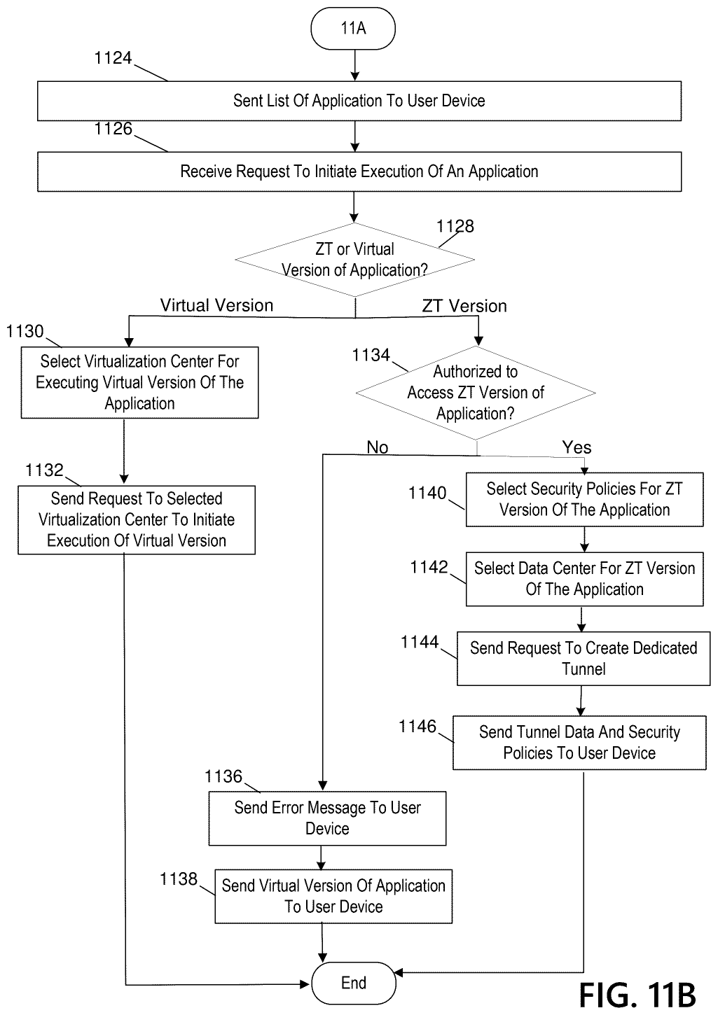

FIGS. 11A and 11B depict illustrative methods for providing virtual and/or ZT versions of applications in accordance with one or more illustrative aspects described herein. For convenience, steps 1102-1146 are shown across FIGS. 11A-11B. However, it should be understood that steps 1102-1146 represent a single method (e.g., step 1124 in FIG. 11B may follow step 1122 in FIG. 11A). The various steps may be performed by the gateway server 308, the application store server 312, the policy engine server 312, the application data centers 324, the virtualization servers 326, or any other desired computing device.

At step 1102, a computing device may store data files for various versions (e.g., virtual or ZT) of a plurality of applications (e.g., stored in the application store server 312). At step 1102, a computing device may receive predetermined conditions that user devices (e.g., the on-premise user device 304 or the remote user device 306) need to meet to access virtual versions and/or ZT versions of the plurality of applications. For example, the computing device may receive data indicating that the ZT version of application A will only be provided to a user device if the user device is connected to the private network of the organization via an ethernet port available at the premises of the organization, the user device is present at the premises of the organization, and the user device is running an anti-virus application. Otherwise, a virtual version of application A will be provided to the user device. The computing device may also receive data indicating that the ZT version of application B may be provided to a user device if the user device is running an anti-virus application and that no other requirements are needed. The data may further indicate that if the user device is not running an anti-virus application, then a virtual version of Application B will be provided to the user device.

At step 1104, the computing device may receive data about security policies that need to be enforced in user devices if the user device is executing ZT versions of the plurality of applications. For example, the data may indicate that there are restrictions on downloading files and capturing screenshots while using the ZT version of application A, and the security policies for application B may indicate restrictions on accessing servers outside the private domain.

At step 1106, the computing device may receive a request from a user device for a list of applications that the user device can access. At step 1108, the computing device may request one or more parameters associated with the user device from the user device. The requested parameters may be associated with the network configurations, device configurations, and/or location of the user device (e.g., the operating system and/or a version of an operating system, a service pack of the operating system, a running service, a running process, a file, presence or versions of various applications of the client, such as antivirus, firewall, security, and/or other software, whether the user device has joined a private domain of the on-premise network 302, whether the user device is connected to a public network or a private network, such as a home network, whether the user device comprises a certificate associated with the private domain or organization, the physical location of the user device, etc.). The computing device may additionally ask for login credentials of a user of the user device and/or the login credentials of the user device. The request may comprise information for password-based authentication, two-factor/multifactor authentication, biometric authentication, single sign-on, token-based authentication, certificate-based authentication, and the like. At step 1110, the computing device may receive the requested user device parameter and/or the login credentials.

At step 1110, the computing device may generate a list of applications that the user device can access. The list of applications may be generated based on the login credentials of the user and/or the user device. At step 1112, the computing device may select an application from the list of applications, and at step 1116, the computing device may determine whether the user device parameters received at step 1110 meet the predetermined conditions for executing a ZT version of the selected application or the predetermined conditions for executing a virtual version of the selected application. If the user device parameters meet the predetermined conditions of the ZT version of the selected application (or do not meet the predetermined requirements of the virtual version), then the data files of the ZT version of the application are included in the list of applications at step 1118. If the user device parameters meet the predetermined conditions of the virtual version of the selected application (or do not meet the predetermined conditions of the ZT version), then the data files of the virtual version of the application are included in the list of applications at step 1120. At step 1122, the computing device may determine whether there are more applications for which the version has not been determined. If there are more applications, the method proceeds to step 1114. Otherwise, the method may proceed to step 1124 in FIG. 11B. At step 1124, the computing device may send the list of applications with data files of the appropriate versions of the applications to the user device.

At step 1126, the computing device may receive a signal indicating that a user device has requested execution of an application from the list of applications. At step 1128, the computing device may determine whether the user device has selected a virtual version of the application or a ZT version of the application. If a virtual version of the application was selected, at step 1130, the computing device may select a virtualization server (e.g., one of the virtualization servers 326) for executing the virtual version. At step 1132, the computing device may send a request to the selected virtualization server to initiate the execution of the virtual version.

If it is determined that a ZT version of the application was selected at step 1128, the computing device may determine whether the user device is authorized to access the ZT version of the application using ZTNA protocols. The user device may be authorized based on validating the user credentials of the user of the user device and/or the device credentials of the user device. Authorizing the user device may further include checking whether the user device parameters meet the predetermined conditions for launching the ZT version of the application. If the user device does not have authorization, at step 1136, the computing device may send an error message to the user device to indicate to the user device that the launching of the ZT version of the application has failed. At step 1138, the computing device may send a virtual version of the application to the user device such that the user device can initiate the execution of the virtual version.

If the user device is authorized to initiate execution of the ZT version, at step 1140, the computing device may send data security policies that are required to be enforced on the ZT version to the user device. At step 1142, the computing device may select an application data center storing data files for the ZT version of the application (e.g., the application data centers 326). At step 1144, the computing device may send a request to create a dedicated secure tunnel between the user device and the selected data center. The request may be sent to the user device with information about the selected application data center so that the user device may create the tunnel. Alternatively, the request may be sent to the selected data center with information about the user device so that the selected data center can create the tunnel. The dedicated tunnel may be based on ZTNA protocol that allows for secure movement of data between the data center and the user device. At step 1146, the computing device may send data about the dedicated tunnel and/or the security policies to the user device.

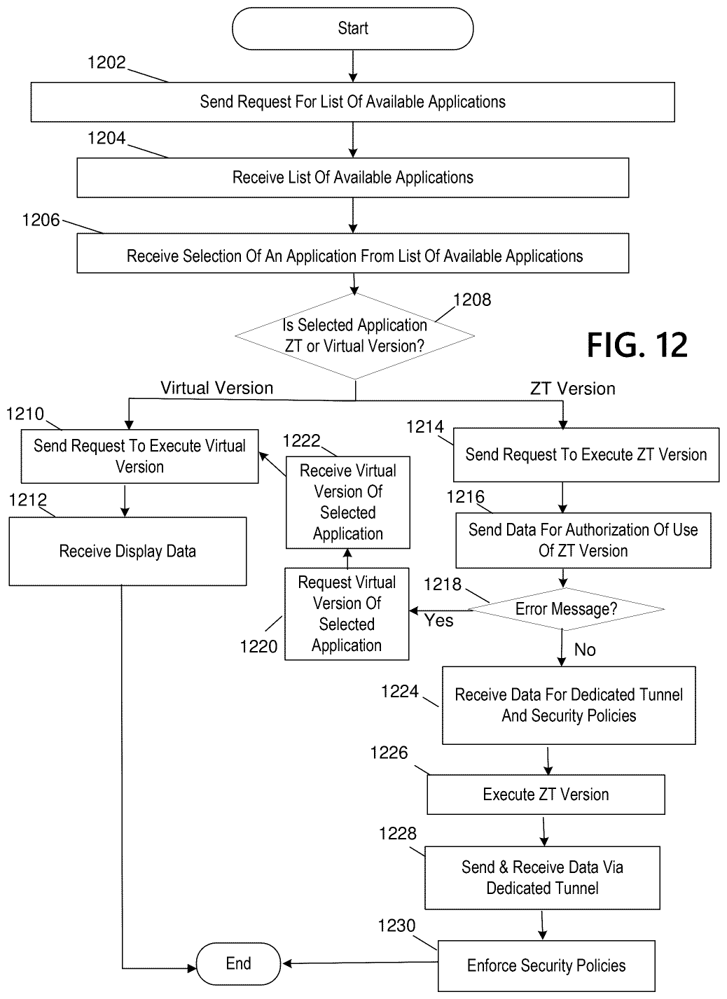

FIG. 12 depicts illustrative methods for a user device to receive virtual and/or ZT versions of applications in accordance with one or more illustrative aspects described herein. It should be understood that steps 1202-1228 may represent a single method. The various steps may be performed by a user device, such as the on-premise user device 304 or the remote user device 306.

At step 1202, the user device may send a request for a list of applications that the user device can access. The request may be automatically sent when an application portal (e.g., the application portal module 702A) is initiated and/or executed at the user device. Additionally, the request may be accompanied by one or more user device parameters associated with the user device. Alternatively, the user device may receive a request for the user device parameters from another device (e.g., the gateway server 308) and send the user device parameters to the other device. The user device parameters may indicate the network configurations, device configurations, and/or location of the user device (e.g., the operating system and/or a version of an operating system, a service pack of the operating system, a running service, a running process, a file, presence or versions of various applications of the client, such as antivirus, firewall, security, and/or other software, whether the user device has joined a private domain of the on-premise network 302, whether the user device is connected to a public network or a private network, such as a home network, whether the user device comprises a certificate associated with the private domain or organization, the physical location of the user device, etc.). In addition to the request for the list of applications, the user may also send login credentials of a user of the user device and/or device credentials of the user device. The login credentials may comprise information for password-based authentication, two-factor/multifactor authentication, biometric authentication, single sign-on, token-based authentication, certificate-based authentication, and the like. The device credentials may comprise public key infrastructure (PKI) certificates, one-time password (OTP) token keys, SIM card numbers, access tokens, and the like. The request for the list of applications, the user device parameters, and/or the login credentials may be sent to a gateway server (e.g., the gateway server 308). At step 1204, the user device may receive the requested list of applications and display the list of applications via a display portal or an application portal (e.g., the application portal 800). The displayed list may only include virtual versions or only include ZT versions. In some embodiments, the displayed list may include a mix of virtual versions and ZT versions.

At step 1206, the user device may receive a selection of an application from the list of applications displayed via the application portal. At step 1208, the user device may determine whether the selected application from step 1208 is a virtual version for execution at a virtualization server or a ZT version for execution at the user device. If the selected application is a virtual version, then the user device may send a request to execute the virtual version of the selected application at a virtualization server (e.g., the virtualization servers 325, 326, 401). The request to execute the virtual version of the selected application may be sent to a gateway server (e.g., the gateway server 308). At step 1212, the user device may receive data for display at the user device. The data may be generated by the virtual version of the selected application executing at a virtualization server. The user device may be executing a thin-client or remote-display application to display the data. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

If it is determined at step 1208 that the selected application is a ZT version, then at step 1214, the user device may send a request for authorization to execute the ZT version with ZTNA protocols. Additionally, at step 1216, the user device may send data that may be used to authorize the user device to execute the ZT version, such as user device parameters (e.g., the current device and network configurations and/or location of the user device 1002), user credentials (e.g., password-based authentication, two-factor/multifactor authentication, biometric authentication, single sign-on, token-based authentication, certificate-based authentication, and the like), and/or device credentials (e.g., public key infrastructure (PKI) certificates, one-time password (OTP) token keys, SIM card numbers, access tokens, and the like).

At step 1218, the user device may determine whether the user device has received an error message indicating that the request for executing the ZT version has been denied. If an error message is received, the user device may request the virtual version of the selected application at step 1220 and receive the virtual version at step 1220, and then the method may proceed to step 1210. If an error message is not received at step 1218, the method proceeds to step 1224.

At step 1224, the user device may receive data for a secure dedicated tunnel between the user device and an application data center storing data files for the ZT version of the selected application. The dedicated secure tunnel may include ZTNA protocols that allow for the secure movement of data between the application data center and the user device. Additionally, the user device may receive security policies that the ZT version is required to enforce during the execution of the ZT version. For example, the security policies may indicate that the ZT version is required to restrict clipboard access, printing, downloading, capturing screenshots, keystroke logging, or the like in the ZT version of the application. Additionally, the security policies may indicate that the ZT version cannot access any internal servers joined to a private domain, and/or servers external to the private domain. At step 1226, the user device executes the ZT version of the application. The executed ZT version may communicate with the data center using the secure dedicated tunnel at step 1228. The user device may enforce the security policies on the ZT version at step 1230.

The following paragraphs (M1) through (M10) describe examples of methods that may be implemented in accordance with the present disclosure.

(M1) A method comprising storing, by one or more computing devices and for an application, a Zero Trust (ZT) version of the application that is configured for local execution and a virtual version of the application that is configured for virtual execution; receiving, from a user device, a request for the application and one or more parameters associated with the user device; selecting, based on the request and the one or more parameters, one of the ZT version of the application and the virtual version of the application; and sending, to the user device, the selected one of the ZT version of the application and the virtual version of the application.

(M2) A method may be performed as described in paragraph (M1) wherein the one or more parameters each indicate one or more of whether the user device has joined a private domain, whether the user device comprises a certificate associated with the private domain, a physical location of the user device, or whether the user device is executing an anti-virus application.

(M3) A method may be performed as described in any of paragraphs (M1) through (M2) further comprising storing, for the application, one or more predetermined conditions associated with sending of the ZT version of the application to the user device, wherein selecting the one of the ZT version of the application and the virtual version of the application comprises selecting, based on determining that the one or more predetermined conditions are met by the one or more parameters, the ZT version of the application, and/or selecting, based on determining that the one or more predetermined conditions are not met by the one or more parameters, the virtual version of the application.

(M4) A method may be performed as described in any of paragraphs (M1) through (M3) wherein receiving the request for the application comprises receiving a request for a list of applications available for the user device, wherein the method further comprising determining, based on the one or more parameters, a first set of ZT applications that are configured for local execution and a second set of virtual applications that are configured for virtual execution; and causing, at the user device, display of a portal comprising the first set of applications and the second set of applications.

(M5) A method may be performed as described in paragraph (M4) wherein the first set of ZT applications and the second set of virtual applications are available from an application store.

(M6) A method may be performed as described in any of paragraphs (M1) through (M5) wherein selecting the one of the ZT version of the application and the virtual version of the application comprises selecting the ZT version of the application, and wherein sending the selected one of the ZT version of the application and the virtual version of the application further comprises sending, to the user device, security policies associated with the ZT version of the application; and causing the user device to execute the ZT version of the application based on the security policies.

(M7) A method may be performed as described in paragraph (M6) wherein the security policies indicate restrictions in one or more of clipboard access, printing, downloading, capturing screenshots, keystroke logging, access to internal servers joined to a private domain, and/or access to servers external to the private domain.

(M8) A method may be performed as described in any of paragraphs (M1) through (M7) wherein the ZT version of the application is configured for local execution at the user device, and the virtual version of the application is configured for virtual execution in one or more virtualization servers.

(M9) A method may be performed as described in paragraph (M8) wherein the one or more computing devices, the user device, and the one or more virtualization servers are joined to a private domain.

(M10) A method may be performed as described in paragraph (M8) wherein the one or more computing devices and the one or more virtualization servers are joined to a private domain and the user device is not joined to the private domain.

The following paragraphs (A1) through (A10) describe examples of apparatuses that may be implemented in accordance with the present disclosure.

(A1) An apparatus comprising one or more processors and memory storing instructions that, when executed by the one or more processors, cause the apparatus to store, for an application, a Zero Trust (ZT) version of the application that is configured for local execution and a virtual version of the application that is configured for virtual execution; receive, from a user device, a request for the application and one or more parameters associated with the user device; select, based on the request and the one or more parameters, one of the ZT version of the application and the virtual version of the application; and send, to the user device, the selected one of the ZT version of the application and the virtual version of the application.

(A2) The apparatus of paragraph (A1), wherein the one or more parameters each indicate one or more of whether the user device has joined a private domain, whether the user device comprises a certificate associated with the private domain, a physical location of the user device, or whether the user device is executing an anti-virus application.

(A3) The apparatus as described in any of paragraphs (A1) through (A2), wherein the instructions, when executed by the one or more processors, further cause the apparatus to store, for the application, one or more predetermined conditions associated with sending of the ZT version of the application to the user device; and select the one of the ZT version of the application and the virtual version of the application by selecting, based on determining that the one or more predetermined conditions are met by the one or more parameters, the ZT version of the application, and/or selecting, based on determining that the one or more predetermined conditions are not met by the one or more parameters, the virtual version of the application.

(A4) The apparatus as described in any of the paragraphs (A1) through (A3) wherein the instructions, when executed by the one or more processors, further cause the apparatus to receive the request for the application by receiving a request for a list of applications available for the user device, and wherein the instructions, when executed by the one or more processors, further cause the apparatus to determine, based on the one or more parameters, a first set of ZT applications that are configured for local execution and a second set of virtual applications that are configured for virtual execution; and cause, at the user device, display of a portal comprising the first set of applications and the second set of applications.

(A5) The apparatus as described in paragraph (A4), wherein the first set of ZT applications and the second set of virtual applications are available from an application store.

(A6) The apparatus as described in any of the paragraphs (A1) through (A5) wherein selecting the one of the ZT version of the application and the virtual version of the application comprises selecting the ZT version of the application, and wherein sending the selected one of the ZT version of the application and the virtual version of the application further comprises sending, to the user device, security policies associated with the ZT version of the application; and causing the user device to execute the ZT version of the application based on the security policies.

(A7) The apparatus as described in paragraph (A6) wherein the security policies indicate restrictions in one or more of clipboard access, printing, downloading, capturing screenshots, keystroke logging, access to internal servers joined to a private domain, and/or access to servers external to the private domain.

(A8) The apparatus as described in paragraphs (A1) through (A7), wherein the ZT version of the application is configured for local execution at the user device, and the virtual version of the application is configured for virtual execution in one or more virtualization servers.

(A9) The apparatus as described in paragraph (A8), wherein the one or more computing devices, the user device, and the one or more virtualization servers are joined to a private domain.

(A10) The apparatus as described in described in paragraph (A8), wherein the one or more computing devices and the one or more virtualization servers are joined to a private domain and the user device is not joined to the private domain.

The following paragraphs (CRM1) through (CRM10) describe examples of computer-readable media that may be implemented in accordance with the present disclosure.

(CRM1) A non-transitory computer-readable medium storing instructions that, when executed, cause a system to perform storing, for an application, a Zero Trust (ZT) version of the application that is configured for local execution and a virtual version of the application that is configured for virtual execution; receiving, from a user device, a request for the application and one or more parameters associated with the user device; selecting, based on the request and the one or more parameters, one of the ZT version of the application and the virtual version of the application; and sending, to the user device, the selected one of the ZT version of the application and the virtual version of the application.

(CRM2) A non-transitory computer-readable medium as described in paragraph (CRM1) wherein the one or more parameters each indicate one or more of whether the user device has joined a private domain, whether the user device comprises a certificate associated with the private domain, a physical location of the user device, or whether the user device is executing an anti-virus application.

(CRM3) A non-transitory computer-readable medium as described in any of paragraphs (CRM1) through (CRM2) further comprising storing, for the application, one or more predetermined conditions associated with sending of the ZT version of the application to the user device, wherein selecting the one of the ZT version of the application and the virtual version of the application comprises selecting, based on determining that the one or more predetermined conditions are met by the one or more parameters, the ZT version of the application, and/or selecting, based on determining that the one or more predetermined conditions are not met by the one or more parameters, the virtual version of the application.

(CRM4) A non-transitory computer-readable medium as described in any of paragraphs (CRM1) through (CRM3) wherein receiving the request for the application comprises receiving a request for a list of applications available for the user device, wherein the method further comprising determining, based on the one or more parameters, a first set of ZT applications that are configured for local execution and a second set of virtual applications that are configured for virtual execution; and causing, at the user device, display of a portal comprising the first set of applications and the second set of applications.

(CRM5) A non-transitory computer-readable medium as described in paragraph (CRM4), wherein the first set of ZT applications and the second set of virtual applications are available from an application store.

(CRM6) A non-transitory computer-readable medium as described in any of paragraphs (CRM1) through (CRM5) wherein selecting the one of the ZT version of the application and the virtual version of the application comprises selecting the ZT version of the application, and wherein sending the selected one of the ZT version of the application and the virtual version of the application further comprises sending, to the user device, security policies associated with the ZT version of the application; and causing the user device to execute the ZT version of the application based on the security policies.

(CRM7) A non-transitory computer-readable medium as described in paragraph (CRM6) wherein the security policies indicate restrictions in one or more of clipboard access, printing, downloading, capturing screenshots, keystroke logging, access to internal servers joined to a private domain, and/or access to servers external to the private domain.

(CRM8) A non-transitory computer-readable medium as described in any of paragraphs (CRM1) through (CRM7) wherein the ZT version of the application is configured for local execution at the user device, and the virtual version of the application is configured for virtual execution in one or more virtualization servers.

(CRM9) A non-transitory computer-readable medium as described in paragraph (CRM8), wherein the one or more computing devices, the user device, and the one or more virtualization servers are joined to a private domain.

(CRM10) A non-transitory computer-readable medium as described in paragraph (CRM8), wherein the one or more computing devices and the one or more virtualization servers are joined to a private domain and the user device is not joined to the private domain.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method, comprising:
storing, by one or more computing devices and for an application:
a Zero Trust (ZT) version of the application that is configured for local execution; and
a virtual version of the application that is configured for virtual execution;
receiving, from a user device:
a request for the application; and
one or more parameters associated with the user device;
selecting, based on the request and the one or more parameters, one of the ZT version of the application and the virtual version of the application; and
sending, to the user device, the selected one of the ZT version of the application and the virtual version of the application.

2. The method of claim 1, wherein the one or more parameters each indicate one or more of:
whether the user device has joined a private domain;
whether the user device comprises a certificate associated with the private domain;
a physical location of the user device; or
whether the user device is executing an anti-virus application.

3. The method of claim 1, further comprising:
storing, for the application, one or more predetermined conditions associated with sending of the ZT version of the application to the user device,
wherein selecting the one of the ZT version of the application and the virtual version of the application comprises:
selecting, based on determining that the one or more parameters meet the one or more predetermined conditions, the ZT version of the application; or
selecting, based on determining that the one or more parameters do not meet the one or more predetermined conditions, the virtual version of the application.

4. The method of claim 1, wherein receiving the request for the application comprises receiving a request for a list of applications available for the user device, the method further comprising:
determining, based on the one or more parameters:
a first set of ZT applications that are configured for local execution; and
a second set of virtual applications that are configured for virtual execution; and
causing, at the user device, display of a portal comprising the first set of applications and the second set of applications.

5. The method of claim 4, wherein the first set of ZT applications and the second set of virtual applications are available from an application store.

6. The method of claim 1, wherein selecting the one of the ZT version of the application and the virtual version of the application comprises selecting the ZT version of the application; and
wherein sending the selected one of the ZT version of the application and the virtual version of the application further comprises:
sending, to the user device, security policies associated with the ZT version of the application; and
causing the user device to execute the ZT version of the application based on the security policies.

7. The method of claim 6, wherein the security policies indicate restrictions in one or more of:
clipboard access, printing, downloading, capturing screenshots, keystroke logging, access to internal servers joined to a private domain, or access to servers external to the private domain.

8. The method of claim 1, wherein the ZT version of the application is configured for local execution at the user device; and
wherein the virtual version of the application is configured for virtual execution in one or more virtualization servers.

9. The method of claim 8, wherein the one or more computing devices, the user device, and the one or more virtualization servers are joined to a private domain.

10. The method of claim 8, wherein the one or more computing devices and the one or more virtualization servers are joined to a private domain and the user device is not joined to the private domain.

11. An apparatus comprising:
one or more processors; and
memory storing instructions that, when executed by the one or more processors, cause the apparatus to:
store, for an application:
a Zero Trust (ZT) version of the application that is configured for local execution; and
a virtual version of the application that is configured for virtual execution;
receive, from a user device:
a request for the application; and
one or more parameters associated with the user device;
select, based on the request and the one or more parameters, one of the ZT version of the application and the virtual version of the application; and
send, to the user device, the selected one of the ZT version of the application and the virtual version of the application.

12. The apparatus of claim 11, wherein the one or more parameters each indicate one or more of:
whether the user device has joined a private domain;
whether the user device comprises a certificate associated with the private domain;
a physical location of the user device; or
whether the user device is executing an anti-virus application.

13. The apparatus of claim 11, wherein the instructions, when executed by the one or more processors, further cause the apparatus to store, for the application, one or more predetermined conditions associated with sending of the ZT version of the application to the user device; and
wherein the instructions, when executed by the one or more processors, further cause the apparatus to select the one of the ZT version of the application and the virtual version of the application by:
selecting, based on determining that the one or more parameters meet the one or more predetermined conditions, the ZT version of the application; or
selecting, based on determining that the one or more parameters do not meet the one or more predetermined conditions, the virtual version of the application.

14. The apparatus of claim 11, wherein the instructions, when executed by the one or more processors, cause the apparatus to:
receive a second request for a list of applications available for the user device;
based on the one or more parameters, determine:
a first set of ZT applications that are configured for local execution; and
a second set of virtual applications that are configured for virtual execution; and
cause, at the user device, display of a portal comprising the first set of applications and the second set of applications.

15. The apparatus of claim 11, wherein the instructions, when executed by the one or more processors, cause the apparatus to select the one of the ZT version of the application and the virtual version of the application by:
selecting the ZT version of the application; and
sending, to the user device, security policies associated with the ZT version of the application; and
causing the user device to execute the ZT version of the application based on the security policies.

16. A non-transitory computer-readable medium storing instructions that, when executed, cause:
storing, for an application:
a Zero Trust (ZT) version of the application that is configured for local execution; and
a virtual version of the application that is configured for virtual execution;
receiving, from a user device:
a request for the application; and
one or more parameters associated with the user device;
select, based on the request and the one or more parameters, one of the ZT version of the application and the virtual version of the application; and
send, to the user device, the selected one of the ZT version of the application and the virtual version of the application.

17. The non-transitory computer-readable medium of claim 16, wherein the one or more parameters each indicate one or more of:
whether the user device has joined a private domain;
whether the user device comprises a certificate associated with the private domain;
a physical location of the user device; or
whether the user device is executing an anti-virus application.

18. The non-transitory computer-readable medium of claim 16, wherein the instructions, when executed, further cause:
storing, for the application, one or more predetermined conditions associated with sending of the ZT version of the application to the user device; and
wherein the instructions, when executed, cause selecting the one of the ZT version of the application and the virtual version of the application by:
selecting, based on determining that the one or more parameters meet the one or more predetermined conditions, the ZT version of the application; or
selecting, based on determining that the one or more parameters do not meet the one or more predetermined conditions, the virtual version of the application.

19. The non-transitory computer-readable medium of claim 16, wherein the instructions, when executed, further cause:
receiving a second request for a list of applications available for the user device;
based on the one or more parameters, determining:
a first set of ZT applications that are configured for local execution; and
a second set of virtual applications that are configured for virtual execution; and
causing, at the user device, display of a portal comprising the first set of applications and the second set of applications.

20. The non-transitory computer-readable medium of claim 16, wherein the instructions, when executed, cause selecting the one of the ZT version of the application and the virtual version of the application by:
selecting the ZT version of the application; and
sending, to the user device, security policies associated with the ZT version of the application; and
causing the user device to execute the ZT version of the application based on the security policies.
